(19) United States
(12) Patent Application Publication
(10) Pub. No.: US 2010/0215028 A1
(43) Pub. Date: Aug. 26, 2010

(54) PROVIDING WIRELESS COVERAGE INTO SUBSTANTIALLY CLOSED ENVIRONMENTS

(75) Inventor: Larry G. Fischer, Waseca, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/775,897

(22) Filed: May 7, 2010

Related U.S. Application Data
(63) Continuation of application No. 11/150,820, filed on Jun. 10, 2005.

(51) Int. Cl. H04W 72/00; G06F 15/16

(52) U.S. Cl. 370/338; 709/246

(57) ABSTRACT

A communication system includes a master host unit, communication links, a remote server unit, an analog communication medium, and remote units. The master host unit communicates analog signals with service provider interfaces using a first set of bands of analog spectrum. The master host unit communicates digitized spectrum in N-bit words across communication links and converts between the first set of bands and N-bit words. The remote server unit communicates N-bit words with the master host unit across communication links and converts between N-bit words and a second set of bands of analog spectrum. The remote server unit communicates the second set of bands with the remote units across the analog communication medium. Each remote unit frequency converts the second set of bands to a third set of bands of analog spectrum and transmits and receives wireless signals, associated with service provider interfaces, over air interfaces.

This application is a continuation of U.S. application Ser. No. 11/150,820, filed on Jun. 10, 2005, and entitled “PROVIDING WIRELESS COVERAGE INTO SUBSTANTIALLY CLOSED ENVIRONMENTS”, which is incorporated herein by reference in its entirety.

### BACKGROUND

In recent years, the telecommunications industry has experienced rapid growth by offering a variety of new and improved services to customers. This growth has been particularly notable in the area of wireless communications, e.g., cellular, personal communication services (PCS) and other mobile radio systems. One of the factors that has led to the rapid growth in the wireless arena is the objective of allowing a user to be reached any time, and anywhere. Unfortunately, the industry has not been able to reach this goal even though large and small companies and various consortiums are frantically building vast networks in an effort to capture a share of this booming market.

Despite their efforts to provide seamless and blanket coverage for wireless telecommunications, areas of limited wireless coverage still exist in heavily populated regions. One particular difficulty is communication within a substantially closed environment, such as a building or other structure which can interfere with radio frequency transmissions. In these situations, the structure itself acts as a barrier and significantly attenuates or reduces the signal strength of the radio waves to the point that transmission is virtually impossible at the frequency and power levels used in these systems.

The industry has developed a number of options to extend coverage into buildings and other substantially closed environments. For example, one solution to this problem has been to distribute antennas within the building. Typically, these antennas are connected to an RF signal source by dedicated coaxial cable, optical fiber, and, more recently, unshielded twisted pair wires. In such systems, various methods of signal conditioning and processing are used, ranging from straight bi-directional on-frequency amplification and band pass filtering to select which service or service provider to transport, to frequency conversion methods to move the signals to a more desirable segment of the frequency spectrum for transport. Some systems also use passive antenna methods and “leaky” coaxial cable to radiate signals within the desired area without any signal conditioning. Unfortunately, with the explosive growth in the wireless market, these solutions often are too limited in capacity to carry signals for the various services and service providers into the closed environment. Thus, the limited benefits of such systems, at times, can be outweighed by the costs associated with the installation and maintenance of the systems.

For the reasons stated above, and for other reasons stated below which will become apparent to those skilled in the art upon reading and understanding the present specification, there is a need in the art for an economically viable system and method for distributing wireless signals in a substantially closed environment.

### SUMMARY

Embodiments of the present invention provide solutions to the problems identified above. In particular, embodiments of the present invention enable economical distribution of wireless signals in a substantially closed environment.

A communication system includes a master host unit, communication links, a remote server unit, an analog communication medium, and remote units. The master host unit communicates analog signals with service provider interfaces using a first set of bands of analog spectrum. The master host unit communicates digitized spectrum in N-bit words across communication links and converts between the first set of bands and N-bit words. The remote server unit communicates N-bit words with the master host unit across communication links and converts between N-bit words and a second set of bands of analog spectrum. The remote server unit communicates the second set of bands with the remote units across the analog communication medium. Each remote unit frequency converts the second set of bands to a third set of bands of analog spectrum and transmits and receives wireless signals, associated with service provider interfaces, over air interfaces.

### BRIEF DESCRIPTION OF THE DRAWINGS

FIG. 1 is a block diagram of one embodiment of a system for providing wireless coverage into a substantially enclosed environment.

FIG. 2 is a block diagram of one embodiment of a master host unit for the system of FIG. 1.

FIG. 3 is a block diagram of one embodiment of a master expansion unit for the system of FIG. 1.

FIG. 4 is a block diagram of one embodiment of remote server unit for the system of FIG. 1.

FIG. 5 is a block diagram of one embodiment of a remote unit of FIG. 1.

### DETAILED DESCRIPTION

In the following detailed description, reference is made to the accompanying drawings which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

### I. Introduction

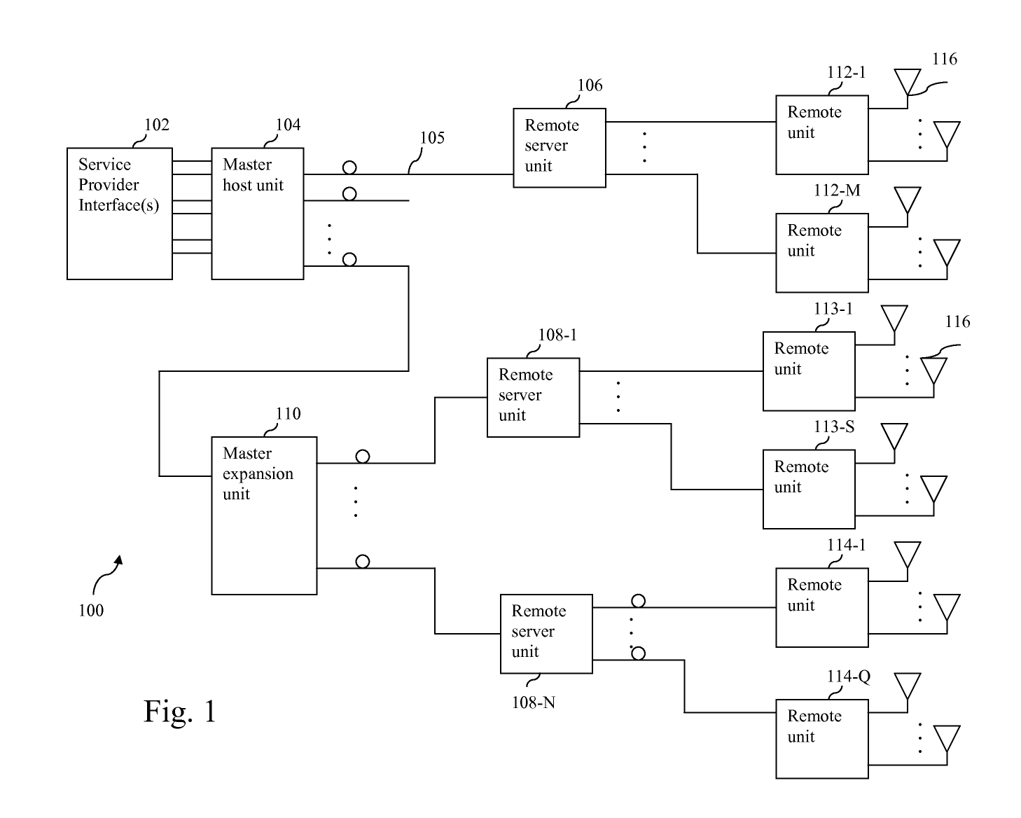

Embodiments of the present invention provide improved wireless coverage into substantially closed environments, e.g., in buildings or other structures. Section II below provides an overview of one embodiment of a network topology shown in FIG. 1 for extending wireless coverage into substantially closed environments according to the teachings of the present invention. In this embodiment, wireless coverage for multiple service providers is carried into one or more structures over a transport network. The transport network includes two main components: a digital transport component and an analog transport component. First, the digital component transports wireless signals as digitized spectrum over, e.g., a fiber optic cable, free space optics, high speed copper, millimeter wave radio link, or other appropriate wired or wireless link for carrying the digital representation of the wireless spectrum. The digital component transports the wireless signals between a service provider interface, e.g., a base station transceiver, a repeater, or other interface to a service provider network, and one or more buildings or other structures that adversely affect the transmission of wireless communication signals. Second, the analog component uses analog transmission, e.g., analog transmission over coax or fiber optic cable, to carry signals to and from antennas placed throughout the coverage area within the structure. In some embodiments, up or down conversion is used to move the wireless signals to a portion of the spectrum to provide improved transmission characteristics, e.g., lower frequency for longer transmission distance.

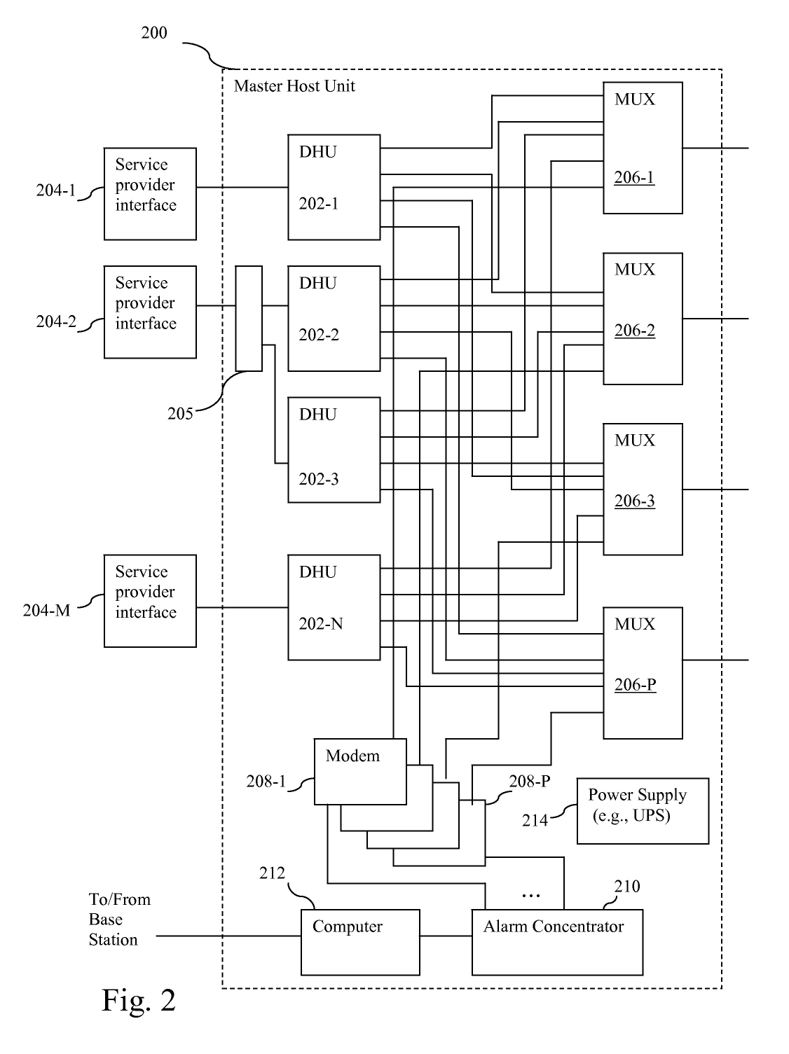

The remainder of the detailed description describes an example implementation of the network topology to extend the coverage of the full 1.9 GHz PCS band and the 800 MHz cellular band into a plurality of buildings as shown in FIGS. 2-5. It is understood that this embodiment is provided by way of example and not by way of limitation. The network topology described in this application is used in other embodiments to carry these and other wireless services into various environments that limit the penetration of standard wireless transmissions.

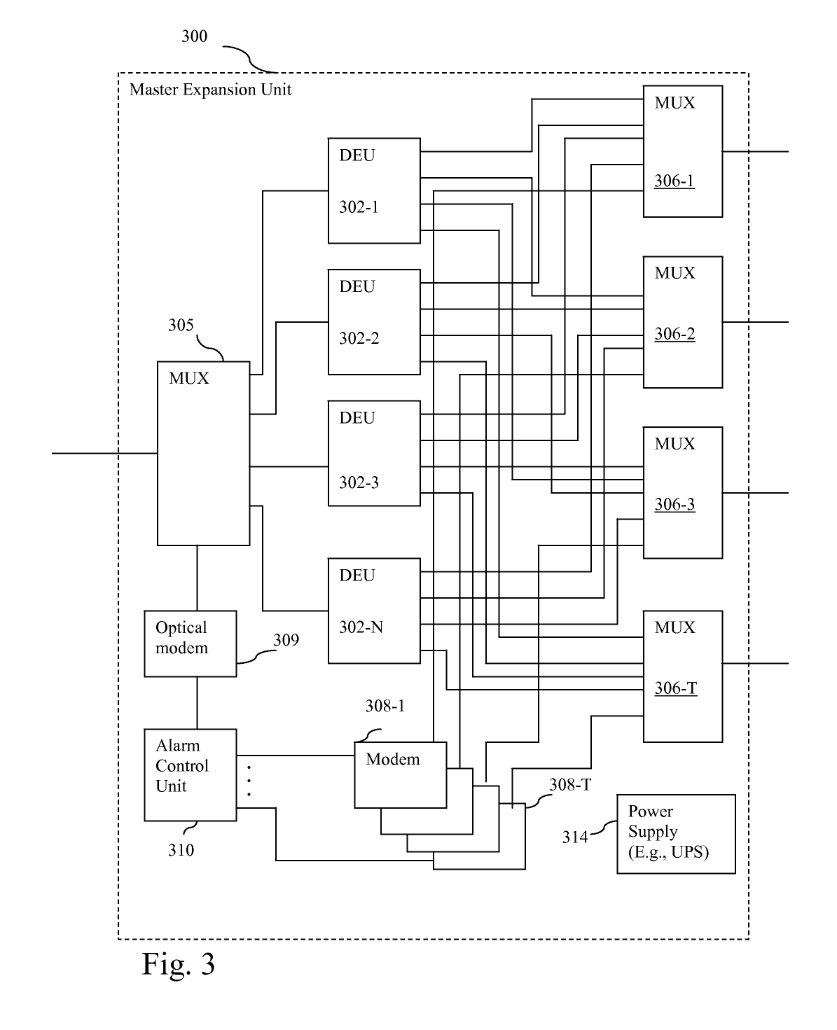

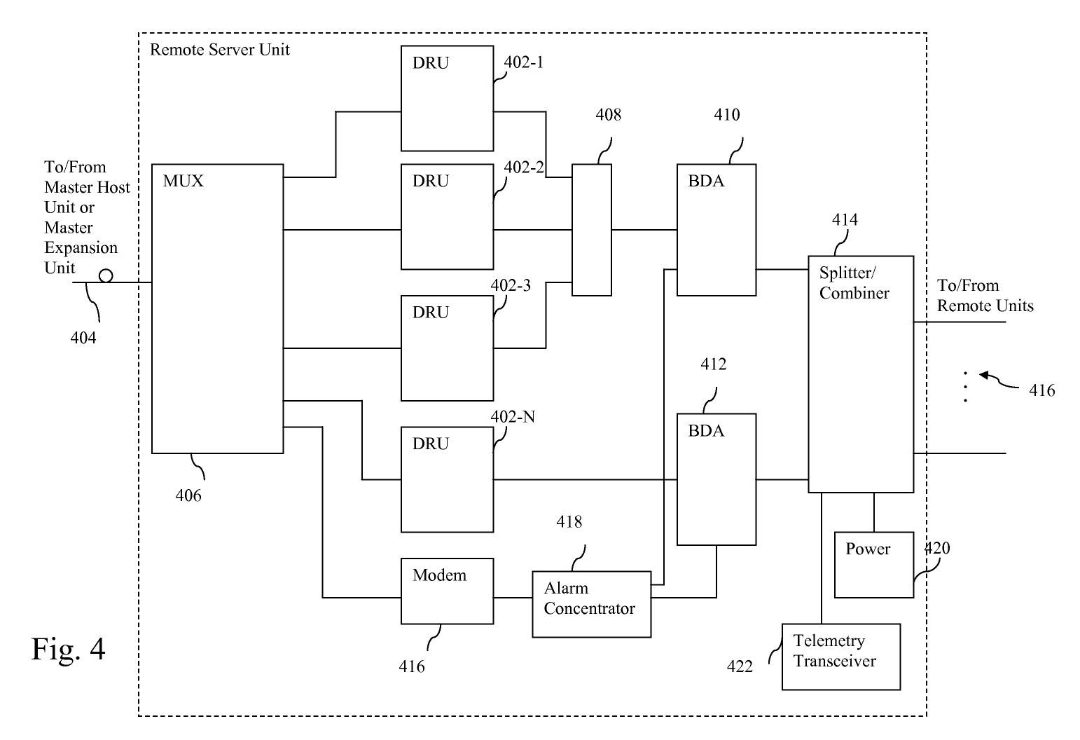

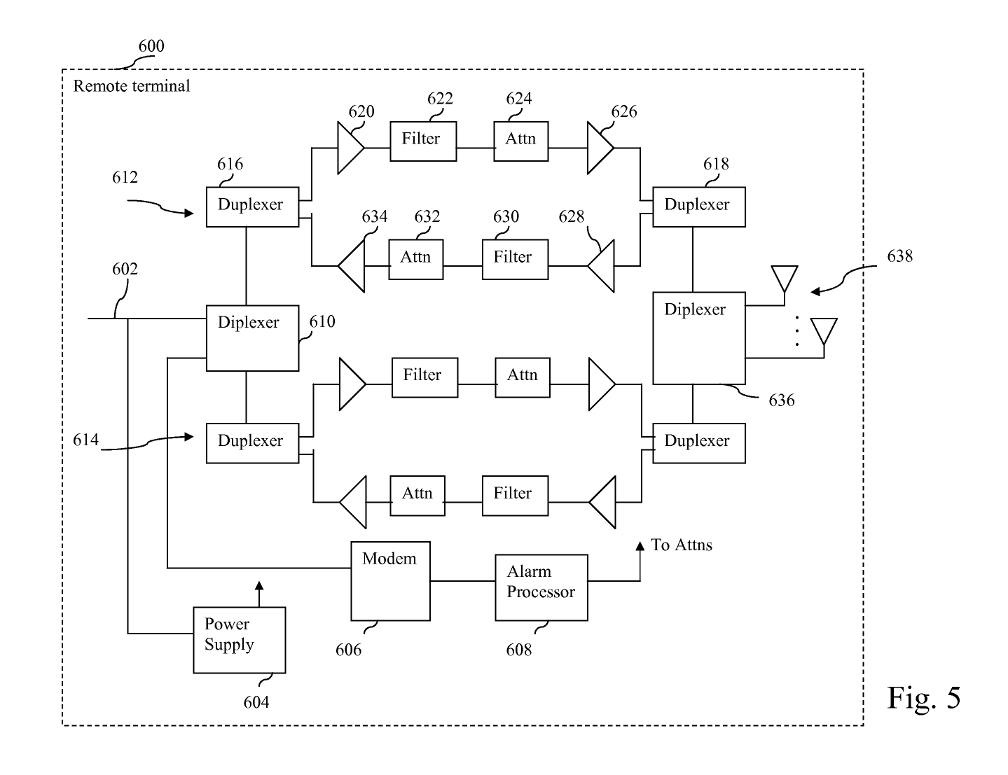

The example implementation shown in FIGS. 2-5 is described in detail below. Section III describes an embodiment of the master host unit of FIG. 2. Section IV describes an embodiment of the master expansion unit of FIG. 3. Section V describes an embodiment of the remote server unit shown in FIG. 4. Section VI describes an embodiment of a remote unit shown in FIG. 5.

### II. Network Topology

FIG. 1 is a block diagram of one embodiment of a system, indicated generally at 100, for providing wireless coverage into a substantially enclosed environment. System 100 transports wireless signals for a plurality of services offered by one or more service providers and extends the coverage of these systems into one or more substantially enclosed environments, e.g., buildings or other structures. At one end of its transport architecture, system 100 includes service provider interface 102. Service provider interface 102 comprises, for example, an interface to one or more of a base transceiver station (BTS), a repeater, a bi-directional amplifier, a base station hotel or other appropriate interface for one or more service provider networks. In one embodiment, service provider interface 102 provides an interface to a plurality of services from one or more service providers, e.g., 800 MHz cellular service, 1.9 GHz personal communication services (PCS), Specialized Mobile Radio (SMR) services, two way paging services, video services or other appropriate communication service.

System 100 uses two main transport protocols to extend the coverage of the wireless services into the substantially enclosed environment. First, system 100 uses digital transport over an appropriate communication medium 105, e.g., optical fiber. Communication medium 105 is represented as optical fiber in FIG. 1 by way of example and not by way of limitation. In other embodiments, communication medium 105 comprises free space optics, high speed copper or other appropriate wired, wireless or optical communication medium. Advantageously, the use of this digital transport technology enables transport of the wireless signals over a significant distance. Thus, system 100 may extend coverage for wireless services to buildings located at a significant distance from the interface to the service provider's network. Second, system 100 extends the reach of the digital transport into the substantially enclosed environment with a plurality of analog transport links to a plurality of remote antennas.

System 100 uses the digital transport technology for communication between master host unit 104 and remote server units 106, and 108-1 to 108-N. In one embodiment, master host unit 104 includes a plurality of ports to subtend remote server units. By way of example and not by way of limitation, master host unit 104, in one embodiment, includes up to six ports for subtending remote server units. In a practical application, the number of ports that can be implemented in a master host unit 104 is primarily limited by the noise in the system. As shown in the example of FIG. 1, the number of remote server units associated with a port of master host unit 104 is increased by interposing a master expansion unit 110 between the port of master host unit 104 and the remote server units 108-1 to 108-N. The master expansion unit 110 digitally splits and sums the signals transported between the master host unit 104 and the remote server units 106 and 108-1 to 108-N. In one embodiment, the master expansion unit 110 is adapted to support up to 4 remote server units. Again, the actual number of ports in a master expansion unit 110 is determined based on the needs of a given system and is primarily limited by the noise level in the system.

Master host unit 104 and remote server units 106, and 108-1 to 108-N convert between analog wireless signals, e.g., analog RF signals, and digitized spectrum. In one embodiment, master host unit 104 includes a bank of individual circuits, such as a bank of Digivance™ Digital Host Units (DHUs) or FLX host unit commercially available from ADC Telecommunications, Inc. of Eden Prairie, Minn., that are each configured to operate on a selected portion of the wireless spectrum. In one embodiment, the DHUs convert between 25 MHz bands of wireless spectrum and digitized samples of the spectrum in the form of 20 bit words. Similarly, remote server units 106 and 108-1 to 108-N, in one embodiment, use a bank of Digivance™ Digital Remote Units (DRUs) or FLX remote units, also available from ADC Telecommunications, Inc. to operate on the selected spectrum. In one embodiment, course wave division multiplexing (CWDM) or dense wave division multiplexing (DWDM) are used to aggregate the signals for the various services onto a single fiber between the master host unit 104 and each of the remote server units 106, and 108-1 to 108-N. In one embodiment, master expansion unit 110 also includes a banks of individual expansion circuits such as a bank of Digivance™ Digital Expansion Units (DEUs) commercially available from ADC Telecommunications, Inc.

The analog portion of system 100 provides communication between the remote server units 106 and 108-1 to 108-N and their respective remote units 112-1 to 112-M, 113-1 to 113-S and 114-1 to 114-Q. The analog portion of system 100 uses one or more of various communication media, e.g., coaxial cable, fiber optic cable or the like, to carry the wireless signals in their native analog frequency spectrum, e.g., their assigned RF spectrum. In other embodiments, the wireless signals are moved to other frequency spectrum for improved transport, e.g., up or down converted. In one embodiment, remote server unit 106 is coupled to remote units 112-1 to 112-M over coaxial cable. In another example, signals from remote server unit 108-N are provided to remote units 114-1 to 114-Q over optical fiber in analog format.

Each remote unit includes one or more antennas 116. In one embodiment, each remote unit supports up to four antennas. In other embodiments, other appropriate numbers of antennas are used.

In one embodiment, remote server units provide power to their respective remote units. For example, remote server unit 106 is coupled to remote units 112-1 to 112-M over coaxial cable. In this embodiment, remote server unit 106 injects power onto the coaxial cable for the circuitry of remote units 112-1 to 112-M. Further, remote units 112-1 to 112-M are equipped with circuitry to extract power from the coaxial cable for the operation of remote units 112-1 to 112-M.

In one embodiment, remote server units provide a telemetry signal to their respective remote units. The telemetry signal is used to adjust the gain applied to signals at the various remote units for the various services supported in system 100. In one embodiment, the telemetry signal is communicated at a frequency between the spectrum for the various services, e.g., at a frequency of 1.4 to 1.6 GHz for a system running 800 MHz cellular and 1.9 GHz PCS services.

In one embodiment, master host unit 104 and the remote server units all include modems for communicating and transporting signals for operations, administration and maintenance (O,A&M) functions such as alarms and the like.

The physical location of the various elements of system 100 varies based on the needs of a given implementation. For example, in some embodiments, the master host unit 104 is co-located with a base station or a base station hotel. In a system 100 that provides coverage into a number of buildings, one or more remote server terminals is provided, e.g., at a point of entry into each building. In other embodiments, a remote server terminal is located on each floor of the building. In yet other embodiments, a master expansion unit is provided at the point of entry into each building and a remote server unit is provided on each floor of the building. The exact location of each of the elements of system 100 is determined based on the specific layout and location of the area or areas to be covered by system 100. The examples provided here are not meant to be exhaustive and thus are not intended to be read in a limiting sense.

In operation, system 100 extends the coverage of at least two wireless services into a substantially enclosed environment. System 100 receives wireless signals for the services at service provider interface 102. Master host unit 104 receives the wireless signals and converts the wireless signals to digitized form. Master host unit 104 also aggregates the various services and passes these aggregated, digitized signals to a plurality of remote server units 106, and 108-1 to 108-N over a digital transport link. At each remote server unit, the signals for the two services are amplified and combined and transmitted over the analog link to a plurality of remote units. In one embodiment, telemetry and power are injected into the combined signal and transmitted to the remote units. At the remote units, the gain of the signals for the services are again adjusted, e.g., based on the telemetry signal, and transmitted over a plurality of antennas in various broadcast areas in the substantially enclosed environment.

Signals from wireless terminals, e.g., cell phones, are returned over system 100 in a similar fashion to the service provider interface 102.

### III. Master Host Unit

FIG. 2 is a block diagram of one embodiment of a master host unit, indicated generally at 200, for the system 100 of FIG. 1. Master host unit 200 is one end of a digital transport link in system 100 of FIG. 1. In this embodiment, master host unit 200 is built around a plurality of circuits 202-1 to 202-N that convert wireless signals between analog and digitized formats. In this example, the circuits 202-1 to 202-N comprise Digivance™ Digital Host Units or FLX host units commercially available from ADC Telecommunications. Other circuits that perform a similar conversion are used in other embodiments.

Master host unit 200 communicates with a plurality of service providers at service provider interfaces 204-1 to 204-M, e.g., interfaces to base transceiver stations, repeaters, bi-directional amplifiers, or the like. These communications are in the form of analog wireless signals (also referred to herein as radio frequency (RF) signals). For purposes of this specification, the term “analog wireless signals” comprises signals in the frequency spectrum used to transport a wireless service, e.g., RF signals in the 800 MHz spectrum for cellular, RF signals in the 1.9 GHz spectrum for Personal Communication Services (PCS), and the like. These signals are referred to as analog signals even if the data for the service is in digital form, e.g., CDMA and TDMA signals, because the digital signals ride on an analog waveform. Advantageously, master host unit 200 enables the aggregation and transmission of a plurality of services to a plurality of buildings or other structures so as to extend the wireless coverage of multiple services into the structures on a single platform.

The interconnection of service provider interfaces 204-1 to 204-M and DHUs 202-1 to 202-N is configured based on the needs of a particular system. In some embodiments, multiple service provider interfaces 204-1 to 204-M are coupled to the same DHU 202-1 to 202-N by use of splitter/combiner circuits. In other embodiments, the same service provider interface 204-1 to 204-M is coupled to multiple DHUs 202-1 to 202-N. In one example, master host unit 200 enables the extension of both the 800 MHz cellular band and the 1.9 GHz PCS band into a plurality of buildings over a single platform. In this embodiment, master host unit 200 includes four DHUs 202-1 to 202-4. DHUs 202-1 to 202-3 are dedicated to handling the three segments of the PCS band and DHU 202-4 is dedicated to the 800 MHz band. Further, service provider interface 204-1 is a base transceiver station and is coupled to DHU 202-1 to provide the first segment of the 1.9 GHz band. Further, service provider interface 204-2 is also a base transceiver station and is coupled through splitter/combiner 206 to provide two PCS segments to DHUs 202-2 and 202-3. Finally, service provider interface 204-3 is a repeater and is coupled to provide 800 MHz service to DHU 202-4. The configuration shown in FIG. 2 is provided by way of example and not by way of limitation. Other configurations to support other combinations of services and service providers are also supported by this architecture.

Each DHU 202-1 to 202-N is coupled to each of a plurality of multiplexer (MUX) circuits 206-1 to 206-P. The DHUs 202-1 to 202-N communicate digitized spectrum for their assigned band with MUX circuits 206-1 to 206-P. The number of MUX circuits 206-1 to 206-P, in one embodiment, is related to the number of ports available on the DHUs 202-1 to 202-N. In one embodiment, the DHUs provide six ports, and thus a maximum of six MUX circuits 206-1 to 206-P are provided. Each MUX circuit 206-1 to 206-P provides a port for communicating aggregated, digitized signals with a remote building or other substantially closed structure. In one embodiment, MUX circuits 206-1 to 206-P comprise optical multiplexer circuits built on course wave division multiplexing (CWDM) or dense wave division multiplexing (DWDM) technology. For example, in one embodiment, MUX circuits 206-1 to 206-P comprise OptEnet optical multiplexers commercially available from ADC Telecommunications, Inc. of Eden Prairie, Minn. In one embodiment, MUX circuits 206-1 to 206-P comprise passive multiplexer modules. In yet other embodiments, MUX circuits 206-1 to 206-P comprise electrical multiplexer circuits.

Master host unit 200 also includes circuitry for providing an Operations, Administration and Maintenance (O, A & M) channel that provides, among other things, a mechanism for passing alarm information in system 100 of FIG. 1. Master host unit 200 includes a bank of modems 208-1 to 208-P. In one embodiment, modems 208-1 to 208-P are optical modems. In other embodiments, wireless or wired modems are used. Each modem 208-1 to 208-P is coupled to a corresponding MUX 206-1 to 206-P. The signals to and from modem 208-1 to 208-P ride on a separate optical carrier of the associated multiplexer circuit. Modems 208-1 to 208-P are coupled to alarm concentrator 210.

Master host unit 200 also includes a computer 212 that is coupled to alarm concentrator 210. In one embodiment, computer 212 runs a network management system for system 100 of FIG. 1. In one embodiment, the computer 212 runs a network management program such as the StarGazer program commercially available from ADC telecommunications, Inc. of Eden Prairie, Minn. The network management program running on computer 212 tracks to location and identification of the parts of system 100. For example, computer 212 assigns a name and an associated location to each part of system 100 at system set-up.

Alarm concentrator 210 communicates and concentrates alarm messages and control messages for system 100. In one embodiment, alarm concentrator 210 receives and concentrates alarm messages from remote units 112-1 to 112-M, 113-1 to 113-S, and 114-1 to 114-Q in system 100. These alarm messages, in one embodiment, include an identification number for the remote unit and a status or alarm message. In other embodiments, other appropriate alarm messages are provided such as messages reporting changes in the attenuation levels applied at a remote unit.

Power for master host unit 200 is provided through power supply 214, e.g., an uninterrupted power supply (UPS).

In operation, master host unit 200 communicates signals between a service provider interface and a number of remote buildings or structures. In the downstream direction, the master host unit 200 receives analog wireless signals from service provider interfaces 204-1 to 204-M. These analog signals are digitized in DHUs 202-1 to 202-N. Each DHU 202-1 to 202-N provides its output to each of MUX circuits 206-1 to 206-P. The MUX circuits 206-1 to 206-P multiplex the signals on, for example, a plurality of optical carriers. Each MUX circuit 206-1 to 206-P provides its output to, for example, a digital optical cable to transport the aggregated, digitized signals to a plurality of buildings or other enclosed structures. In the upstream direction, the MUX circuits 206-1 to 206-P direct the appropriate digitized spectrum to the associated DHUs 202-1 to 202-N for conversion to analog wireless signals for the associated service provider interface 204-1 to 204-M. Modems 208-1 to 208-P process alarm messages for their assigned MUX circuit 206-1 to 206-P.

### IV. Master Expansion Unit

FIG. 3 is a block diagram of one embodiment of a master expansion unit, indicated generally at 300, for the system 100 of FIG. 1. Master host unit 300 enables point-to-multipoint communication in the digital transport link of system 100 by digitally splitting and summing signals transmitted between the master host unit and the remote server units. In this embodiment, master expansion unit 300 is built around a plurality of circuits 302-1 to 302-N that digitally split and sum wireless signals in digitized format. Each circuit 302-1 to 302-N is associated with a portion of the wireless spectrum transported by the system. Each circuit 302-1 to 302-N digitally splits its assigned spectrum in the downstream so that the spectrum is provided to a plurality of remote server units. In the upstream, each circuit 302-1 to 302-N digitally sums signals from all of the remote server units for its assigned spectrum. In this example, the circuits 302-1 to 302-N comprise Digivance™ Digital Expansion Units commercially available from ADC Telecommunications. Other circuits that perform a similar digital splitting and summing are used in other embodiments.

Master expansion unit 300 communicates with a master host unit, e.g., master host unit 200 of FIG. 2. These communications are in the form of digitized spectrum for a plurality of services. In one embodiment, master expansion unit 300 is coupled to the master host unit over a fiber optic cable that carries the plurality of services as digitized spectrum with each service (digitized spectrum) associated with a different wavelength on the optical fiber. The number of services and the association of a service with a selected wavelength is determined based on the needs of a particular application. In one example, master expansion unit 300 is associated with a system that enables the extension of both the 800 MHz cellular band and the 1.9 GHz PCS band into a plurality of buildings over a single platform. In this embodiment, master expansion unit 300 includes four DEUs 302-1 to 302-4. DEUs 302-1 to 302-3 are dedicated to handling the three segments of the PCS band and DEU 302-4 is dedicated to the 800 MHz band. Further, multiplexer (MUX) circuit 305 is coupled to DEUs 302-1 to 302-N to provide the appropriate digitized spectrum to and from each DEU. In one embodiment, MUX circuit 305 comprises an optical multiplexer circuit built on course wave division multiplexing (CWDM) or dense wave division multiplexing (DWDM) technology, using, e.g., an OptEnet optical multiplexer commercially available from ADC Telecommunications. In one embodiment, MUX circuit 305 comprises passive multiplexer modules. In yet other embodiments, MUX circuit 305 comprises electrical multiplexer circuits.

Each DEU 302-1 to 302-N is coupled to each of a plurality of multiplexer (MUX) circuits 306-1 to 306-T. The DEUs 302-1 to 302-N communicate digitized spectrum for their assigned band with MUX circuits 306-1 to 306-T. The number of MUX circuits 306-1 to 306-T, in one embodiment, is related to the number of ports available on the DEUs 302-1 to 302-N. In one embodiment, the DEUs provide six ports, and thus a maximum of six MUX circuits 306-1 to 306-T are provided. Each MUX circuit 306-1 to 306-T provides a port for communicating aggregated, digitized signals for all of the supported services with a remote building or other substantially closed structure. In one embodiment, MUX circuits 306-1 to 306-T comprise optical multiplexer circuits built on course wave division multiplexing (CWDM) or dense wave division multiplexing (DWDM) technology. For example, in one embodiment, MUX circuits 306-1 to 306-T comprise OptEnet optical multiplexers commercially available from ADC Telecommunications, Inc. of Eden Prairie, Minn. In one embodiment, MUX circuits 306-1 to 306-T comprise passive multiplexer modules. In yet other embodiments, MUX circuits 306-1 to 306-T comprise electrical multiplexer circuits.

Master expansion unit 300 also includes circuitry for providing an Operations, Administration and Maintenance (O, A & M) channel that provides, among other things, a mechanism for passing alarm information in system 100 of FIG. 1. Master expansion unit 300 includes a first modem 309 that is coupled to MUX circuit 306. Modem 309 is also coupled to alarm control unit 310. Alarm control unit 310 is also coupled to a bank of modems 308-1 to 308-T. In one embodiment, modems 308-1 to 308-T are optical modems. In other embodiments, modems 308-1 to 308-T are wireless or wired modems. Each modem 308-1 to 308-T is coupled to a corresponding MUX 306-1 to 306-T. The signals to and from modem 308-1 to 308-T ride on a separate optical carrier of the associated multiplexer circuit to communicate alarm messages with the remote server units. Alarm control unit 310 passes alarm messages between the master host unit and the remote server units via modem 309 and modems 308-1 to 308-T.

Power for master expansion unit 300 is provided through power supply 314, e.g, uninterrupted power supply (UPS).

In operation, master expansion unit 300 communicates signals between a master host unit and a remote server unit in a communication system that extends wireless coverage into a plurality of buildings. In the downstream direction, the master expansion unit 300 receives digitized wireless signals on a plurality of carriers at MUX 305 from a master host unit or another master expansion unit. The MUX circuit 305 separates the signals according to the various services and passes the signals to associated DEUs 302-1 to 302-N. These digitized signals are digitally split in DEUs 302-1 to 302-N. Each DEU 302-1 to 302-N provides its output to each of MUX circuits 306-1 to 306-T. The MUX circuits 306-1 to 306-P multiplex the signals from the DEUs 302-1 to 302-N on, for example, a plurality of optical carriers to provide an aggregated signal representing all of the digital wireless services. Each MUX circuit 306-1 to 306-T provides an output to, for example, a digital optical cable to transport the aggregated, digitized signals to a plurality of buildings or other enclosed structures.

In the upstream direction, the MUX circuits 306-1 to 306-T direct the appropriate digitized spectrum to the associated DEUs 302-1 to 302-N for digital summation. The DEUs 302-1 to 302-N provide the summed outputs for the digitized spectrum for the associated services to MUX circuit 306 for transmission to a master host or another master expansion unit.

Alarm control unit 310 and modems 309 and 308-1 to 308-P process alarm messages for the master expansion unit 300. Alarm control unit 310 receives messages from the remote units via the associated modems 308-1 to 308-T. Further, alarm control unit 310 passes alarms and other messages to selected remote units through their associated modem 308-1 to 308-T.

### V. Remote Server Unit

FIG. 4 is a block diagram of one embodiment of remote server unit, indicated generally at 400, for the system 100 of FIG. 1. Remote server unit 400 is the other end of the digital transport portion of the system 100 of FIG. 1. In this embodiment, remote server unit 400 is built around a plurality of circuits 402-1 to 402-N that convert wireless signals between analog and digitized formats. In this example, the circuits 402-1 to 402-N comprise Digivance™ Digital Remote Units (DRUs) or FLX remote units commercially available from ADC Telecommunications. In this embodiment, the circuits or DRUs 402-1 to 402-N convert signals between analog wireless signals, such as the 800 MHz cellular band and the 1.9 GHz PCS band, and digitized samples in 20 bit words. Other circuits that perform a similar conversion are used in other embodiments.

Remote server unit 400 communicates with a master host unit, such as master host unit 200 of FIG. 2, over a digitized communication link 404. In one embodiment, the communication link 404 carries the digitized spectrum for circuits 402-1 to 402-N on a plurality of multiplexed carriers, e.g., optical frequencies. Remote server unit 400 includes multiplexer (MUX) circuit 406 to multiplex the signals for the plurality of circuits 402-1 to 402-N. In one embodiment, MUX circuit 406 comprises an optical multiplexer circuit built on course wave division multiplexing (CWDM) or dense wave division multiplexing (DWDM) technology. For example, in one embodiment, MUX circuit 406 comprises an OptEnet optical multiplexer commercially available from ADC Telecommunications, Inc. of Eden Prairie, Minn. MUX circuit 406 communicates digitized signals with DRUs 402-1 to 402-N by associating a particular carrier with each DRU 402-1 to 402-N.

As with the master host unit 200 of FIG. 2, the remote server unit 400 is configurable based on the wireless services to be transported through the unit. Continuing the example from FIG. 2, DRUs 402-1 to 402-3 are associated with three segments of the 1.9 GHz PCS band. Thus, the RF ports of the DRUs 402-1 to 402-3 are coupled to splitter/combiner 408. Splitter/combiner 408 is further coupled to communicate the 1.9 MHz PCS analog spectrum to and from bidirectional amplifier 410. Further, DRU 402-4 is associated with the 800 MHz cellular service. The DRU 402-4 communicates the 800 MHz analog cellular spectrum to and from bidirectional amplifier 412. Bidirectional amplifiers 410 and 412 communicate their analog representations of their respective bands with splitter/combiner 414. Splitter/combiner 414 provides an interface 416 to a plurality of remote units such as remote units based on remote unit 600 of FIG. 5. In one embodiment, interface 416 includes a plurality of ports, e.g., 4 or more ports. These ports communicate the combined analog spectrum of all services supported by the remote server unit 400 over an analog transport segment. In some embodiments, these ports are adapted for analog coaxial cable. In other embodiments, these ports are adapted for use with analog optical fiber. In some embodiments, the analog spectrum is moved to a different spectrum to provide improved communication over longer distances, e.g., downconverted to a lower spectrum for transmission on coaxial cable.

Remote server unit 400 also includes modem 416 and alarm concentrator 418 as part of an alarm mechanism for the communication system. In one embodiment, modem 416 is an optical modem. In other embodiments, modem 416 is a wireless or wired modem. Alarm concentrator 418 receives alarm and other messages from the remote units over interface 416. Alarm concentrator 418 passes these messages upstream through modem 416. In the downstream direction, messages for the remote units are received at modem 416 and provided to the appropriate remote unit through alarm concentrator 418.

Remote server unit 400 also includes a telemetry transceiver 422 coupled to splitter combiner 414. Telemetry transceiver 422 injects a signal into transmissions from the remote server unit 400 to the remote units. This signal is used by the remote units to adjust their attenuation levels based on the distance between the remote server unit 400 and the remote unit due to the affect of the length of a coaxial cable on the signal strength. In one embodiment, the telemetry signal is transmitted at frequency between the frequency ranges of the services transported over the system. For example, a telemetry signal with a frequency from 1.4 to 1.6 GHz is used when carrying both 800 MHz cellular service and 1.9 GHz PCS.

Power is also injected onto the signal at interface 416. Power is supplied via power supply 420. The power is injected onto each communication line extending from interface 416.

### VI. Remote Unit

FIG. 5 is a block diagram of one embodiment of a remote unit, indicated generally at 600, for use in system 100 of FIG. 1. Remote unit 600 is located at one end of an analog transport portion of the system of FIG. 1 and is typically located within an enclosed environment. Typically, a particular implementation of a system 100 includes a plurality of remote units such as remote unit 600.

Remote unit 600 provides one or more air interfaces to wireless terminals for various service providers. Remote unit 600 communicates with a remote server unit, such as remote server unit 400 of FIG. 4 at port 602. In one embodiment, port 602 is coupled to a coaxial cable and receives power and telemetry signals from the remote server unit. In other embodiments, the port 602 is coupled to a fiber optic cable and thus power is not included in the signal.

When the remote terminal is remotely powered from the remote server unit, port 602 is coupled to power supply 604. Power is extracted from the signal at port 602 and provided to power supply 604. Power supply 604 provides power the rest of the circuitry in remote terminal 600.

Port 602 is also coupled to control carrier modem 606 to process the telemetry signal from the remote server unit. Modem 606 receives the telemetry signal from the remote server unit and passes the signal to alarm processor 608. Alarm processor 608 uses the information in the telemetry signal to determine the appropriate levels of attenuation for the various services supported by the remote terminal. The telemetry signal is used to compensate for differences in attenuation caused by different lengths of coaxial cable between the various remote units associated with a common remote server unit. In one embodiment, the remote terminal supports 800 MHz cellular service as well as the full 1.9 GHz PCS band. The telemetry signal is received at a frequency of, for example, 1.4 to 1.6 GHz. Based on the level of the telemetry signal, alarm processor 608 sets the appropriate attenuation level for processing the 800 MHz analog wireless signals and a separate attenuation level for processing 1.9 GHz analog wireless signals.

Port 602 also communicates analog wireless signals to and from the remote server unit. In one embodiment, the analog wireless signal includes both 800 MHz cellular service as well as the full 1.9 GHz PCS band. Remote terminal 600 includes separate paths for processing the various services supported. Port 602 is coupled to diplexer 610. Diplexer 610 splits and combines the signals for the various services supported by the remote terminal between a first path 612, e.g., for 800 MHz cellular, and a second path 614, e.g., for 1.9 GHz PCS.

First path 612 processes the 800 MHz signals both in the upstream and downstream directions. Duplexers 616 and 618 are located at either end of the first path 612 and separate the path into processing for the upstream signals and processing for the downstream signals. The downstream signals are processed by amplifier 620, filter 622, attenuator (Attn) 624 and amplifier 626 coupled in series between the duplexers 616 and 618. Filter 622 selects the appropriate downstream frequency band. Attenuator 624 attenuates the signal according to the level established by alarm processor 608. In the upstream direction, first path 612 includes amplifier 628, filter 630, attenuator (Attn) 632, and amplifier 634 coupled in series between duplexer 618 and duplexer 616. Filter 630 selects the upstream frequency band for the supported service and attenuator 632 provides the appropriate attenuation as set by alarm processor 608. Second path 614 operates in a similar manner and thus is not described further here.

The first and second paths 612 and 614 are coupled to diplexer 636. Diplexer 636 is also coupled to a plurality of antennas 638 over communication media, e.g., coaxial cable. In other embodiments, separate antennas are provided for each of paths 612 and 614.

In operation, remote unit 600 transmits and receives analog wireless signals for at least two services. In the downstream direction, a signal is received at port 602. This signal includes, in one embodiment, analog wireless signals in the 800 MHz band and in the 1.9 GHz band as well as power and telemetry signals. The power is extracted by power supply 604 which powers the operation of the circuitry of the remote unit 600. The telemetry signal is also received and processed by modem 606 and alarm processor 608. Alarm processor 608 generates signals to control attenuation in paths 612 and 614.

Remote unit 600 also processes the combined analog wireless signals. In the downstream direction, signals for the two services are separated in diplexer 610. The 800 MHz band is processed in path 612 and the 1.9 GHz band is processed in the 614 path. The signals are recombined in diplexer 636 and transmitted over the air interface at antennas 638. In the upstream direction, signals for the two services are received at the antennas 638 and separated at diplexer 636. Again, the 800 MHz band is processed in path 612 and the 1.9 GHz band is processed in the 614 path. The downstream signals are recombined at diplexer 610 for analog transport to the host remote server unit at port 602.

What is claimed is:

1. A communication system, comprising:
a master host unit adapted to communicate analog signals with a plurality of service provider interfaces using a first set of bands of analog spectrum;
a plurality of communication links coupled to the master host unit, wherein the master host unit is further adapted to communicate digitized spectrum in N-bit words over the plurality of communication links;
the master host unit further adapted to convert between the first set of bands of analog spectrum for the plurality of service provider interfaces and N-bit words of digitized spectrum for the plurality of communication links;
at least one remote server unit, communicatively coupled to the master host unit over at least one of the plurality of communication links and adapted to communicate N-bit words of digitized spectrum with the master host unit across the at least one of the plurality of communication links, the at least one remote server unit further adapted to convert between the N-bit words of digitized spectrum and a second set of bands of analog spectrum;
an analog communication medium coupled to the at least one remote server unit, wherein the at least one remote server unit is further adapted to communicate the second set of bands of analog spectrum across the analog communication medium; and
a plurality of remote units, each communicatively coupled to one of the at least one remote server units over the analog communication medium and adapted to communicate the second set of bands of analog spectrum with the one of the at least one remote server units across the analog communication medium, each of the plurality of remote units further adapted to communicate wireless signals using a third set of bands of analog spectrum over a plurality of air interfaces for the associated service provider interfaces.

2. The system of claim 1, wherein each of the plurality of remote units is further adapted to frequency convert between the second set of bands of analog spectrum and the third set of bands of analog spectrum.

3. The system of claim 1, wherein the first set of bands of analog spectrum are the same as the third set of bands of analog spectrum.

4. The system of claim 1, wherein the first set of bands of analog spectrum, the second set of bands of analog spectrum, and the third set of bands of analog spectrum are the same.

5. The system of claim 1, wherein the at least one remote server unit is further adapted to condition the second set of bands of analog spectrum.

6. The system of claim 5, wherein the at least one remote server unit is adapted to condition the second set of bands of analog spectrum using at least one of a splitter, a combiner, an amplifier, an attenuator, and a telemetry transceiver.

7. The system of claim 1, wherein at least one of the plurality of remote units is further adapted to condition the second set of bands of analog spectrum.

8. The system of claim 7, wherein at least one of the plurality of remote units is further adapted to condition the second set of bands of analog spectrum using at least one of an amplifier, a filter, an attenuator, a diplexer, and a modem adapted to receive telemetry signals from the at least one remote server unit.

9. The system of claim 1, wherein the circuitry of the master host unit for converting between analog signals and digitized spectrum comprises a plurality of host units that each are adapted to operate on signals in a selected frequency band.

10. The system of claim 9, wherein the master host unit includes a multiplexer coupled to each of the plurality of host units.

11. The system of claim 1, wherein the master host unit includes a plurality of modems for communicating alarm information between the master host unit and the remote units.

12. The system of claim 1, where the at least one remote server unit injects power for the plurality of remote units.

13. The system of claim 1, wherein the at least one remote server unit includes a telemetry transceiver that is used by the remote units to adjust the attenuation/gain applied to signals in various frequency bands.

14. The system of claim 12, wherein the telemetry receiver communicates at a frequency between the frequency bands of at least two of the analog signals.

15. The system of claim 1, further including a master expansion unit interposed between the master host unit and at least two remote server units.

16. The system of claim 1, wherein the digital communication medium comprises at least one of an optical cable, free space optics, millimeter wave radio link, wireless medium, and high speed copper.

17. A method for providing coverage for wireless signals into at least one substantially closed environment, the method comprising:
converting wireless spectrum for at least two wireless services at a master host unit between a first set of bands of analog spectrum and N-bit words of digitized spectrum, the first set of bands of analog spectrum having a first set of frequencies;
transporting the N-bit words of digitized spectrum as a multiplexed signal on a digital media between the master host unit and a remote server unit;
converting wireless spectrum for the at least two wireless services between the N-bit words of digitized spectrum and a second set of bands of analog spectrum at the remote server unit, the second set of bands of analog spectrum having a second set of frequencies;
transporting the second set of bands of analog spectrum between the remote server unit and at least one remote unit having an air interface for each of the at least two wireless services;
communicating the wireless spectrum in analog format at the at least one remote unit.

18. The method of claim 17, further comprising:
frequency converting between the second set of bands of analog spectrum and a third set of bands of analog spectrum at the at least one remote unit, the third set of bands of analog spectrum having a third set of frequencies, the third set of bands of analog spectrum being communicated at the at least one remote unit.

19. The method of claim 17, wherein the first set of frequencies equals the third set of frequencies.

20. The method of claim 17, wherein the first set of frequencies, the second set of frequencies, and the third set of frequencies are equal.

21. The method of claim 17, further comprising transporting alarm and other messages between the master host unit and the at least one remote unit.

22. The method of claim 17, further comprising providing power from the remote server unit to the at least one remote unit.

23. The method of claim 17, further comprising conditioning the second set of bands of analog spectrum at the remote server unit.

24. The method of claim 23, wherein conditioning the second set of bands of analog spectrum at the remote server unit includes at least one of splitting, combining, amplifying, and attenuating the second set of bands of analog spectrum.

25. The method of claim 17, further comprising conditioning the second set of bands of analog spectrum at the at least one remote unit.

26. The method of claim 25, wherein conditioning the second set of bands of analog spectrum at the at least one remote unit includes at least one of amplifying, filtering, attenuating, and diplexing the second set of bands of analog spectrum.

27. A communication system for providing wireless coverage for at least two wireless services in a plurality of buildings, the system comprising:
a master host unit having a base station interface and a transport interface, the base station interface adapted to communicate using a first set of bands of analog spectrum with the at least two wireless services, wherein the master host unit is configured to convert between the first set of bands of analog spectrum and N-bit words of digitized spectrum;
a plurality of remote server units, each remote server unit disposed in one of the plurality of buildings and associated with a port of the transport interface of the master host unit, wherein each remote server unit is configured to convert between the N-bit words of digitized spectrum and a second set of bands of analog spectrum;
a plurality of digital communication links, each of the digital communication links coupled between one port of the transport interface and the associated remote server unit, the digital communication links carrying the N-bit words of digitized spectrum for each of the services;
a plurality of analog communication links for each of the plurality of remote server units, the analog communication links carrying the second set of bands of analog spectrum for each of the services; and
a plurality of remote units, each of the plurality of remote units coupled to a port of one of the plurality of remote server units over one of the plurality of analog communication links, the remote units providing an air interface for each of the at least two wireless services.

28. The communication system of claim 27, wherein the first set of bands of analog spectrum equals the second set of bands of analog spectrum.

29. The communication system of claim 27, wherein at least one of the plurality of remote units is further configured to convert between the second set of bands of analog spectrum and a third set of bands of analog spectrum, wherein the third band of analog spectrum is communicated at the remote unit using the air interface for each of the at least two wireless services.

30. The communication system of claim 29, wherein the first set of bands of analog spectrum equals the third set of bands of analog spectrum.

31. The communication system of claim 27, wherein at least one of the plurality of remote server units provides power to at least one of the plurality of remote units via the at least one of the plurality of analog communication links

32. The communication system of claim 27, wherein alarm messages are transferred between the master host unit and at least one of the plurality of remote units.

33. The communication system of claim 27, wherein at least a first digital communication link of the plurality of digital communication links is configured for point-to-multipoint transmission, wherein the first digital communication link couples a first port of the transport interface with a first plurality of associated remote server units, the first digital communication link configured to digitally split first signals received from the first port of the transport interface and send the resulting signals to the plurality of associated remote server units, the first digital communication link further configured to digitally sum second signals received from the plurality of associated remote server units and send the resulting signal to the first port of the transport interface.

34. The communication system of claim 27, wherein the at least one remote server unit is further adapted to condition the second set of bands of analog spectrum.

35. The communication system of claim 34, wherein the at least one remote server unit is adapted to condition the second set of bands of analog spectrum using at least one of a splitter, a combiner, an amplifier, an attenuator, and a telemetry transceiver.

36. The communication system of claim 27, wherein at least one of the plurality of remote units is further adapted to condition the second set of bands of analog spectrum.

37. The communication system of claim 36, wherein at least one of the plurality of remote units is further adapted to condition the second set of bands of analog spectrum using at least one of an amplifier, a filter, an attenuator, a diplexer, and a modem adapted to receive telemetry signals from the at least one remote server unit.
